(19) United States
(12) Patent Application Publication
(10) Pub. No.: US 2026/0197081 A1
(43) Pub. Date: Jul. 9, 2026

(54) Uplink Adaptor for Optical Links and Method therefor

(71) Applicant: Airbus Defence and Space Netherlands B.V., Leiden (NL)

(72) Inventor: Thomas Dreischer, Noordwijk (NL)

(73) Assignee: Airbus Defence and Space Netherlands B.V., Leiden (NL)

(21) Appl. No.: 19/132,883

(22) PCT Filed: Dec. 1, 2023
(86) PCT No.: PCT/NL2023/050634

§ 371 Date: May 27, 2025

(30) Foreign Application Priority Data
Dec. 1, 2022 (NL) 2033651

(51) Int. Cl. H04B 10/118; H04B 10/50

(52) U.S. Cl. CPC H04B 10/118; H04B 10/503

(57) ABSTRACT

Provided herein is a method for controlling an optical uplink to a spacecraft, including: providing an output laser beam pointing to a location along a trajectory of the spacecraft through a path in the atmosphere; the output laser beam provided with a beam waist. The method includes monitoring an image pattern obtained from a first image of a beam received from the location and a second image of a reference beam from the output laser beam; determining from the monitored image pattern a relative turbulence strength for the received laser beam along the path in the atmosphere, the turbulence strength based on a beam waist value of the output laser beam and a Fried parameter related value and/or a measured isoplanatic angle; comparing the relative turbulence strength with a predetermined performance factor value; based on the comparison, determining control of the output laser beam either using a divergence control for the beam expanding device or using a wavefront correction control for the wavefront corrector, and a processing unit is configured to select the wavefront correction control if the relative turbulence strength exceeds the predetermined performance factor value, and else to select the divergence control of the output laser beam.

### TECHNICAL FIELD

The invention relates to a device for providing an optical uplink to a spacecraft or an object moving in airspace. Also the invention relates to a method for controlling an optical uplink to a spacecraft.

### BACKGROUND

An optical uplink between a ground station and a spacecraft typically consists of a laser beam that is launched from the ground station to the space craft. The signal carried by the laser beam is known to suffer from strong dynamic losses caused by receive irradiance scintillation at the receiving node. Such losses limit for instance a solid clock recovery, adversely affecting communication over the uplink.

In the prior art, tip-tilt corrections are carried out by adaptive optics to adjust the wavefront of the optical signal. When tip-tilt corrected, a sufficiently small beam waist (beam radius) of the launching beam can minimize dynamic loss penalty at a given turbulence strength along the beam path through the atmosphere.

In L. Andrews et al, “Laser Propagation through random media”, 2^{nd} edition, 2005, FIG. 12.16, (https://doi.org/10.1117/3.626196) an example is shown of an on-axis scintillation index for a laser beam as a function of the beam radius which shows a minimum of the index around a given optimal value of the beam radius at a given turbulence strength of the atmosphere. FIG. 4 shows a prior art illustration of on-axis scintillation index for a laser beam as a function of the beam radius at a given turbulence strength of the atmosphere in accordance with Andrews.

A measure of the turbulence strength Is given by the so-called Fried parameter ‘r₀’ which is a fundamental coherence length measure that characterizes the spatial resolution effects of atmospheric turbulence. In K. Saucke et. al., “Characterisation of the optical channel GEO to ground . . . ”, SPIE proceedings 11852, June 2021, an example of observed variation of the Fried parameter is given, indicating that the parameter, and thus turbulence, typically varies, both on average and on a short term time scale.

In the 1970s, the principle of ‘reciprocity tracking’ was derived, in combination with mathematical proof of reciprocity of the turbulent atmospheric channel. See “Reciprocity of the Turbulent Atmosphere”, J. H. Shapiro, Journal of the Optical Society of America, vol 61, nr 4, page 492, April 1971.

Pre-compensation adaptive optics are known as a means to adapt to such turbulence conditions, also at higher modes than tip-tilt.

International patent application WO 2006/028795 describes an integrated wavefront correction module for correcting an optical signal.

European patent EP3034984B1 describes a method and device for locally stabilizing a radiation spot on a remote target object, using a correction based on tip/tilt.

While pre-compensation works perfectly with ground-aircraft links, the necessary ‘point-ahead’ angle in ground-space laser communications was soon found to significantly limit the achievable effectiveness of reciprocity tracking in ground-to-satellite uplink scenarios. See “Point-ahead limitation on reciprocity tracking”, J. H. Shapiro, Journal of the Optical Society of America, vol 65, nr 1, page 65, April 1975.

Site measurement reports show the isoplanatic angle gets close or below a critical threshold [see for instance upper right figure on page 46 in “European Extremely Large Telescope Site Characterization, II: High angular resolution parameters” by H. V. Ramió et al., arXiv 1207.4229v1, 2012] that inhibits full reciprocity tracking to satellites, which means it then only allows a sub-set of the corresponding adaptive phase pre-compensation to be effective on an uplink beam, the minimum being tip-tilt correction. Moreover, an attempt to pre-compensate higher order modes would in critical threshold condition deteriorate the optimal pre-correction performance and thus needs to be prevented.

The isoplanatic angle relates to the angular size of an isoplanatic patch, i.e., an arbitrary area of the sky over which the path length of incoming electromagnetic waves (such as light or radio waves) only varies by a relatively small amount relative to their wavelength.

An approximation was derived for the effectiveness, approximated by a performance reduction factor that consists of a weighted ratio of magnitudes of the point ahead angle ‘θ_{PAA}’ and the so-named isoplanatic angle ‘θ_{ISO}’, a second integrated turbulence parameter. It shall be noted, however, that this factor in its simple expression is an asymptotic limit for higher order modes and not as severe for lower order modes.

For space-ground uplinks, an optimization is missing that takes into account the maximum order of pre-correction induced by point ahead limitation for a ‘adapted reciprocity tracking’, because only relying on the Fried parameter is not sufficient data throughput optimization on an uplink to a satellite.

It is an object of the present invention to overcome or mitigate one or more of the disadvantages from the prior art.

### SUMMARY OF THE INVENTION

To maximize the uplink data throughput, a 2-dimensional parameter optimization is implemented that takes into account the current turbulence state expressed by in-situ determined parameters Fried parameter ‘r₀’ and isoplanatic angle ‘θ_{ISO}’, plus the current state of point ahead-angle ‘θ_{PAA}’. As a boundary condition, the optimization includes knowledge of the current selected adaptive modulation, coding and interleaving (MODCOD) capabilities of on-board processing in space, if activated.

The object is achieved by a device as defined in claim 1, for providing an optical uplink to a spacecraft, comprising
a laser source, a projection lens system, a beam expanding device, an optical detector, a wavefront correction system, and a processing unit;
the laser source configured for generating a substantially parallel output laser beam,
an optical path for the output laser beam being defined between the laser source and the projection lens system;
the beam expanding device being arranged in the optical path and configured for receiving the output laser beam from the laser source, adjusting a beam waist of the output laser beam and directing the adjusted laser beam to the projection lens system;
the projection lens system configured for receiving the adjusted laser beam and pointing a line of sight of the received laser beam to a location along a trajectory of the spacecraft through a path in the atmosphere;
the optical detector coupled to the projection lens system, configured for monitoring an image pattern obtained from at least a first image of a beam received from said location and a second image of a reference beam from the output laser beam;
the optical detector comprising an image detector, the image detector configured for providing a digital image of the monitored image pattern;
the device further comprising a 2D tiltable mirror in the optical path between the beam expanding device and the projection lens system, the 2D tiltable mirror configured for adjusting an angular position of the laser beam relative to the projecting lens system;
the wavefront correction system comprising a wavefront detector and camera, a pre-compensation beam guiding element, a pre-compensation controller, and a wavefront corrector;
the wavefront corrector arranged in the optical path between the beam expanding device and the 2D tiltable mirror;
the processing unit communicatively coupled to the optical detector, the beam expanding device, the wavefront controller and the wavefront detector,
the processing unit being configured for:
   determining from the monitored image pattern a relative turbulence strength for the received laser beam along said path in the atmosphere, the turbulence strength based on a beam waist value of the output laser beam and a Fried parameter related value;
   comparing the relative turbulence strength with a predetermined performance factor value;
   based on the comparison, determining control of the output laser beam either using a divergence control for the beam expanding device or using a wavefront correction control for the wavefront corrector,
wherein the processing unit is configured to select the wavefront correction control if the relative turbulence strength exceeds the predetermined performance factor value, and else to select the divergence control of the output laser beam.

According to the invention, the uplink laser beam follows reciprocity tracking as a function of the observed isoplanatic angle, in combination with an optimization algorithm that includes knowledge of the spacecraft terminal's current point-ahead angle and of its capabilities for applying adaptive modulation and coding techniques (MODCOD, VCM ‘variable coding and modulation’). As a first step, depending on the current weighted ratio of ‘θ_{PAA}’ and ‘θ_{ISO}’, the maximum effective order of pre-compensation is determined by a dedicated algorithm and thus prevents malicious effects caused by over-compensating too high radial orders. In a second step, an underlying beam adaptor sizes in optimal way the beam waist radius to the current state of the atmospheric transmission channel, weighted with an algorithm that includes capabilities of the selected MODCOD scheme. Following the optimization algorithm, the beam is then sized both, by means of an uplink divergence control for a collimated beam diameter and an optional, additional higher order pre-compensation module involving wavefront correction of an outgoing laser beam.

A ground station is equipped with the outgoing laser beam configured to provide an uplink with a spacecraft that is in line of sight of the ground station while passing. The laser beam is generated by the ground station and is pointed to a location in space on the (anticipated) trajectory of the spacecraft. A ‘beam waist set point’ is set by the laser optics at an optimum value, following the 2-parameter optimization algorithm. The spot of the laser beam seen by the ground station in the direction of the location is monitored with respect to its position and/or intensity, together with a second spot received by the spacecraft. An optical detector is used for such monitoring and it comprises all required functionality to ensure that key parameters like for instance dynamic loss of the received intensity and angle-of-arrival motion and log-amplitude variance of the received intensity along line-of-sight to the spacecraft can be determined.

From those key parameters a measure of the isoplanatic angle and of the turbulence strength (Fried parameter) along the path of the laser beam through the atmosphere are estimated. Based on the isoplanatic angle and the turbulence strength measure in combination with data based on the current MODCOD setting the beam waist is adjusted in a manner that uplink data rate throughput is maximized. To this end the laser beam diameter is adjusted by a beam expanding device that is placed in the optical path of the laser.

Given the above described minimum of the on-axis scintillation index around a given setpoint of the beam radius at a given turbulence strength of the atmosphere as observed by Andrews, there is a certain range R, or slack, of the beam waist around the beam waist setpoint that allows for absorbing fast dynamic variations without a need to adjust the beam waist set point, hence, reduces the need for fast (i.e., near-kHz) adaptation of the divergence-control/beam adjustment. As a result, divergence control according to the invention can be achieved by a relatively slow beam expanding device instead of a relatively fast adaptive optics device, at comparatively less costs.

According to an aspect, the invention relates to method for controlling an optical uplink to a spacecraft, comprising:
providing a substantially parallel output laser beam pointing to a location along a trajectory of the spacecraft through a path in the atmosphere;
the output laser beam being provided with a beam waist;
the method further comprising:
   monitoring an image pattern obtained from a first image of a beam received from said location and a second image of a reference beam from the output laser beam;
   determining from the monitored image pattern a relative turbulence strength for the received laser beam along said path in the atmosphere, the turbulence strength based on a beam waist value of the output laser beam and a Fried parameter related value;
   comparing the relative turbulence strength with a predetermined performance factor value;
   based on the comparison, determining control of the output laser beam either using a divergence control for the beam expanding device or using a wavefront correction control for the wavefront corrector,
wherein the processing unit is configured to select the wavefront correction control if the relative turbulence strength exceeds the predetermined performance factor value, and else to select the divergence control of the output laser beam.

Moreover the invention relates to a computer program product on computer readable medium, holding instructions to be executed on a processing unit of a device as described above, the instructions after being loaded, allowing the processing unit to
determine from the monitored image pattern a relative turbulence strength for the received laser beam along said path in the atmosphere, the turbulence strength based on a beam waist value of the output laser beam and a Fried parameter related value;
compare the relative turbulence strength with a predetermined performance factor value;
based on the comparison, determine control of the output laser beam either using a divergence control for the beam expanding device or using a wavefront correction control for the wavefront corrector,
wherein the processing unit is instructed to select the wavefront correction control if the relative turbulence strength exceeds the predetermined performance factor value, and else to select the divergence control of the output laser beam.

Advantageous embodiments are further defined by the dependent claims.

### BRIEF DESCRIPTION OF DRAWINGS

The invention will be explained in more detail below with reference to drawings in which illustrative embodiments thereof are shown. The drawings are intended exclusively for illustrative purposes and schematic in nature. For some of the elements in the drawings the size and orientation may be exaggerated and not necessarily drawn on scale. The scope of the invention is only limited by the definitions presented in the appended claims.

FIG. 1 shows schematically an optical device for an uplink to an earth orbiting spacecraft, according to an embodiment of the invention;

FIG. 2 shows schematically an optical device for an uplink to an earth orbiting spacecraft, according to an embodiment of the invention;

FIGS. 3A, 3B illustrate a variation of dynamic turbulence loss at three turbulence related levels for two beam waist sizes, and

FIG. 4 shows a prior art illustration of on-axis scintillation index for a laser beam as a function of the beam radius at a given turbulence strength of the atmosphere;

FIG. 5 shows a diagram for obtaining a minimum order from a turbulence-related performance factor;

FIG. 6 schematically shows a distribution of the achievable number (normalized) of Zenike modes as a function of the isoplanatic angle θ_{ISO} (normailized) and the effective wavefront correction (WFC) modes (normalized).

FIGS. 7a-7d, 8a-8d schematically show how in scheme B a wavefront correction is established for long term and short term historical measurements of isoplanatic angle θ_{ISO}, respectively.

### DETAILED DESCRIPTION OF EMBODIMENTS

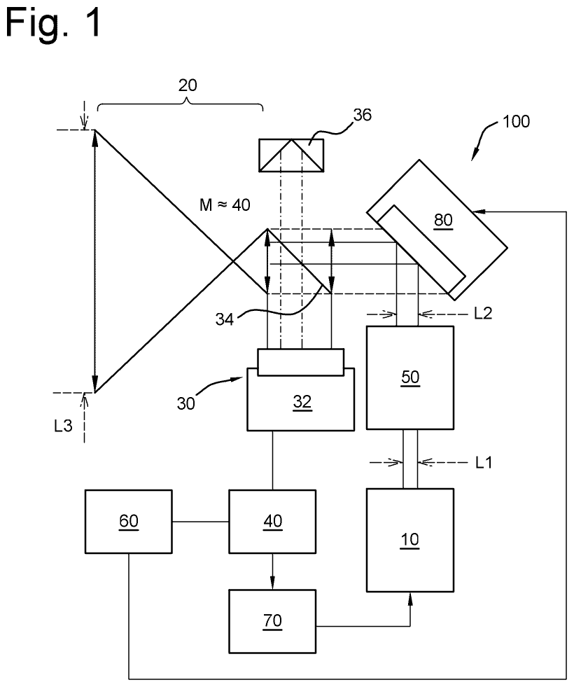

FIG. 1 shows schematically an optical device for an uplink to an earth orbiting spacecraft, according to an embodiment of the invention.

The optical device 100 is part of a ground station that is configured for providing a laser beam pointed up into the sky to a position of an earth orbiting spacecraft passing over the ground station.

The optical device 100 comprises a laser source 10, a projection lens system 20, an optical detector 30, a processing unit 40 and a beam expanding device 50.

The laser source 10 is configured to generate a substantially parallel collimated laser beam B which during use is on an optical path to the projection lens system 20. In the optical path for the laser beam between the laser source 10 and the projection lens system 20 a beam expanding device 50 is arranged configured for adjusting a beam diameter L1 or beam waist of the laser beam coming in from the laser source 10.

The projection lens system 20 is configured for outputting the laser beam as a parallel beam. During operation the projection lens system is oriented such that the output laser beam points to a desired position in the sky, relating to a position of a spacecraft passing overhead. Typically, the projection lens system 20 is or comprises a magnifying lens system comprising a set of optical elements for magnifying the diameter of the laser beam to a size L3 suitable for uplink communication with the spacecraft.

The optical detector 30 comprises power measurement functionality, an image detector 32 and beam guiding element(s) 34, 36. The optical detector 30 is coupled to the projection lens system 20 such that the image detector 32 is configured to capture during operation an image of the laser beam received from the spacecraft through the projection lens system 20. The capturing of the image of the laser beam may comprise a tracking operation by the optical device which causes the output laser beam to point to the targeted space craft.

Also the optical detector 30 is configured to capture an image of the output laser beam as a reference beam by means of the beam guiding elements 34, 36.

The beam guiding elements may comprise additional optical element(s), or maybe configured, to project the image of the beam from the spacecraft which may be a single spot or a pattern of multiple spots, and the image of the reference beam (which also may be a single spot or a pattern of multiple spots) separately from each other in different areas of the image detector.

According to an embodiment, the beam guiding elements comprise a semi-transparent mirror 34 arranged in the optical path from the laser source towards the projection lens system 20, such that a portion of the output laser beam is internally reflected towards the image detector, i.e., is split off, and the beam guiding elements comprise a reflecting element 36 that is aligned with the semi-transparent mirror and the image detector, and reflects and directs the split-off portion of the laser beam to the image detector 32.

Thus, the image detector 32 captures a reference beam from the split-off output laser beam and a spacecraft beam spot pattern of the beam received from the spacecraft.

The reference beam and spacecraft beam images are projected as a spot pattern on the image detector 32. The residual difference between the centres of the reference beam image and spacecraft beam image depends on the relative motion vectors and the distance between spacecraft and ground station. The output laser beam has to lead toward the perceived position of the spacecraft at time of uplink arrival.

From the detected reference beam and spacecraft beam images key parameters comprising dynamic loss of the received intensity and a reference beam intensity are determined. Other key parameters comprise for example angle-of-arrival motion.

The optical detector 30 is configured to provide an output signal that is proportional to the intensity of the captured receive image.

The optical detector 30 is communicatively coupled with the processing unit 40.

The processing unit 40 is typically coupled with memory for holding instructions and/or data, and for example is a computer device or a (micro) controller device as known in the art.

The output signal from the optical detector 30 is fed to the processing unit 40 which is arranged to receive the output signal from the optical detector 30 and to determine a variation of the detected signal as a function of time. The processing unit 40 is configured to determine a dynamic receive loss and an angle of arrival motion which contribute as key parameters to a measure for a turbulence strength along the path of the laser beam through the atmosphere towards the position of the spacecraft. As described below, in an embodiment the processing unit 40 is configured to combine the dynamic receive loss with a 2-axis tracking signal as derived from a tracking controller device 60.

Further, the processing unit is coupled with, or comprises, a controller 70 which is coupled to the beam expanding device 50 for controlling beam expansion settings of the beam expanding device as a function of the turbulence strength as determined from the dynamic loss. The beam expanding device provides a beam diameter L2, equal to or larger than the beam diameter L1 originating from the laser source 10.

The processing unit 40 can be any suitable type of computational unit such as a processor coupled to a memory, in which the memory is arranged to hold program instructions and/or data, allowing processing unit to control the optical device to carry out the method as described above. The processing unit further may be equipped with other interfaces as known in the art, for example a storage device or a wired or wireless network interface for communications.

The optical device is capable of carrying out a method for controlling an optical uplink to a spacecraft or object moving in airspace, comprising:
providing a substantially parallel output laser beam pointing to a location along a trajectory of the spacecraft through a path in the atmosphere;
the output laser beam being provided with a beam waist;
the method further comprising adjustment of the output laser beam, the adjustment comprising:
   monitoring an image pattern obtained from a first image of a beam received from said location and a second image of a reference beam from the output laser beam;
   carrying out at least one of step a) and step b)
a) determining from the monitored image pattern a receive dynamic loss of intensity of the received laser beam along said path in the atmosphere;
   adjusting the beam waist of the laser beam depending on the receive dynamic loss in a manner that an uplink dynamic loss is reduced;
b) determining from the monitored image pattern angular motion of the beam received from said location relative to the reference beam, and
adjusting the beam waist of the laser beam depending on the determined angular motion in a manner that the uplink dynamic loss is reduced.

As will be explained below in more detail, to make use of a substantially reduced channel transmission penalty if the turbulence strength decreases, the beam waist is to be enlarged, up to a maximum value as allowed by the projection lens system. If the turbulence strength increases, the beam waist is to be reduced.

In an embodiment the laser source provides a parallel laser beam with for example a wavelength of 1.55 μm and a diameter of 2 mm. The beam expanding device 50 is configured to expand the diameter to 4 mm for the expanded beam. According to this embodiment, the projection lens system 20 has a fixed magnification of 40. Thus in this embodiment the beam waist of the beam in the atmosphere can be adjusted up to a value of 80 mm. The skilled in the art will appreciate that without limitation of the inventive concept other optical settings and/or beam sizes could be used depending on specific designs or requirements. Also, other laser beam wavelengths could be used.

As mentioned above, the present invention recognizes that in an uplink optical beam a certain range R, or slack, of the beam waist around the beam waist setpoint exists that allows for absorbing fast dynamic variations without a need to adjust the beam waist set point.

Accordingly, in a preferred embodiment, the beam waist is only adjusted when a change of the turbulence strength exceeds a threshold or tolerance value at which change of turbulence strength the quality level of the laser beam becomes adversely affected in a significant manner. If the changes are less than the threshold or tolerance value, the beam waist set point is adequate for maintaining the uplink and is thus kept unchanged. This allows that adjustment of the laser beam can be relatively slow in

In an embodiment, the threshold or tolerance value is derived from a predetermined condition which may correspond to user's requirements for a particular configuration of the uplink adaptor.

In an embodiment, the optical device additionally comprises a tracking controller 60 which may be part of the processing unit 40 or may be coupled to the processing unit 40 and a 2D tiltable mirror 80 (i.e., tiltable along two axes in two perpendicular directions) that is arranged in the optical path between the beam expanding device 50 and the projection lens system 20.

The combination of the tracking controller 60 and the 2D tiltable mirror is configured to keep the laser beam directed to the spacecraft while the spacecraft is in line of sight with the ground station. The tracking controller 60 is configured to receive a position signal of the monitored reference beam and spacecraft beam spot centres (directly or indirectly from the optical detector 30), to determine a position correction signal to correct for misalignment and to send a control signal for position correction of the output laser beam to the 2D tiltable mirror 80. The 2D tiltable mirror 80 is arranged to adjust its orientation in accordance with the control signal received from the tracking controller 60.

According to an embodiment, the beam expanding device 50 is a conventional adjustable telescopic beam expander. In a further embodiment, the telescopic beam expander is attached to a gimbal (not shown) that provides coarse pointing toward the target line of sight. Alternatively, the beam expanding device 50 is combined with one or more meta-surface based elements (not shown) in which the meta-surface based element(s) are capable to control the tilt wavefront of the laser beam radiation in large angle steps, hence eliminating any external movable parts.

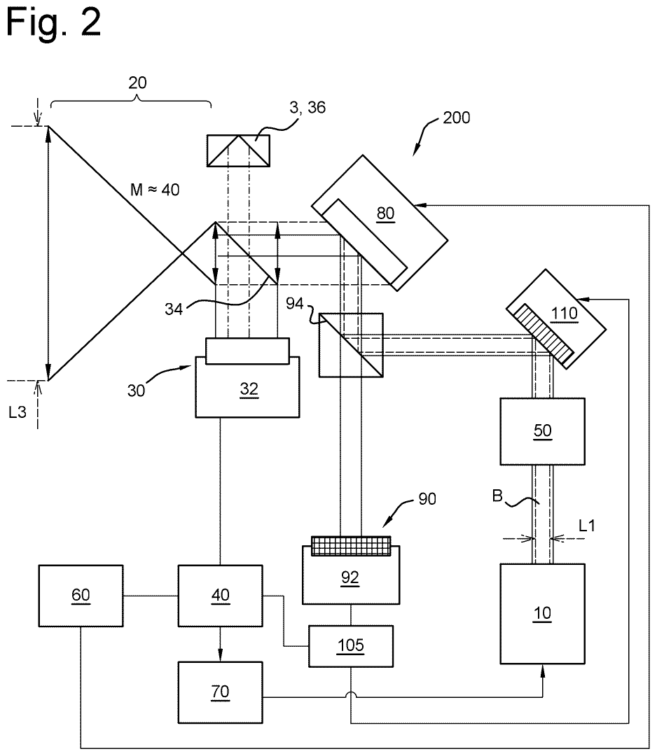

FIG. 2 shows schematically an optical device for an uplink to an earth orbiting spacecraft, according to an embodiment of the invention.

The optical device 200 is part of a ground station that is configured for providing a laser beam pointed up into the sky to a position of an earth orbiting spacecraft passing over the ground station.

The optical device 200 comprises a laser source 10, a projection lens system 20, an optical detector 30, a processing unit 40, a beam expanding device 50, and a wavefront correction system 90, 92, 94, 105, 110.

The laser source 10 is configured to generate a substantially parallel collimated laser beam B which during use is on an optical path to the projection lens system 20. In the optical path for the laser beam between the laser source 10 and the projection lens system 20 a beam expanding device 50 is arranged configured for adjusting a beam diameter L1 or beam waist of the laser beam coming in from the laser source 10.

The projection lens system 20 is configured for outputting the laser beam as a parallel beam. During operation the projection lens system is oriented such that the output laser beam points to a desired position in the sky, relating to a position of a spacecraft passing overhead. Typically, the projection lens system 20 is or comprises a magnifying lens system comprising a set of optical elements for magnifying the diameter of the laser beam to a size L3 suitable for uplink communication with the spacecraft.

The optical detector 30 comprises power measurement functionality, an image detector 32 and beam guiding element(s) 34, 36. The optical detector 30 is coupled to the projection lens system 20 such that the image detector 32 is configured to capture during operation an image of the laser beam received from the spacecraft through the projection lens system 20. The capturing of the image of the laser beam may comprise a tracking operation by the optical device which causes the output laser beam to point to the targeted space craft.

Also the optical detector 30 is configured to capture an image of the output laser beam as a reference beam by means of the beam guiding elements 34, 36.

The beam guiding elements may comprise additional optical element(s), or maybe configured, to project the image of the beam from the spacecraft which may be a single spot or a pattern of multiple spots, and the image of the reference beam (which also may be a single spot or a pattern of multiple spots) separately from each other in different areas of the image detector.

According to an embodiment, the beam guiding elements comprise a semi-transparent mirror 34 arranged in the optical path from the laser source towards the projection lens system 20, such that a portion of the output laser beam is internally reflected towards the image detector, i.e., is split off, and the beam guiding elements comprise a reflecting element 36 that is aligned with the semi-transparent mirror and the image detector, and reflects and directs the split-off portion of the laser beam to the image detector 32.

Thus, the image detector 32 captures a reference beam from the split-off output laser beam and a spacecraft beam spot pattern of the beam received from the spacecraft.

The reference beam and spacecraft beam images are projected as a spot pattern on the image detector 32. The residual difference between the centres of the reference beam image and spacecraft beam image depends on the relative motion vectors and the distance between spacecraft and ground station. The output laser beam has to lead toward the perceived position of the spacecraft at time of uplink arrival.

From the detected reference beam and spacecraft beam images key parameters comprising dynamic loss of the received intensity and a reference beam intensity are determined. Other key parameters comprise for example angle-of-arrival motion.

The optical detector 30 is configured to provide an output signal that is proportional to the intensity of the captured receive image.

The optical detector 30 is communicatively coupled with the processing unit 40.

The processing unit 40 is typically coupled with memory for holding instructions and/or data, and for example is a computer device or a (micro) controller device as known in the art.

The output signal from the optical detector 30 is fed to the processing unit 40 which is arranged to receive the output signal from the optical detector 30 and to determine a variation of the detected signal as a function of time. The processing unit 40 is configured to determine a dynamic receive loss and an angle of arrival motion which contribute as key parameters to a measure for a turbulence strength along the path of the laser beam through the atmosphere towards the position of the spacecraft. As described below, in an embodiment the processing unit 40 is configured to combine the dynamic receive loss with a 2-axis tracking signal as derived from a tracking controller device 60.

Further, the processing unit is coupled with, or comprises, a controller 70 which is coupled to the beam expanding device 50 for controlling beam expansion settings of the beam expanding device as a function of the turbulence strength as determined from the dynamic loss. The beam expanding device provides a beam diameter L2, equal to or larger than the beam diameter L1 originating from the laser source 10.

The processing unit 40 can be any suitable type of computational unit such as a processor coupled to a memory, in which the memory is arranged to hold program instructions and/or data, allowing processing unit to control the optical device to carry out the method as described above. The processing unit further may be equipped with other interfaces as known in the art, for example a storage device or a wired or wireless network interface for communications.

The optical device additionally comprises a tracking controller 60 which may be part of the processing unit 40 or may be coupled to the processing unit 40, and a 2D tiltable mirror 80 (i.e., tiltable along two axes in two perpendicular directions) that is arranged in the optical path between the beam expanding device 50 and the projection lens system 20. The tracking controller 60 is configured to adjust the orientation of the the projection lens system 20 to follow an anticipated path of a spacecraft along a trajectory in the sky.

The wavefront correction system of the optical device comprises a wavefront detector and camera 90, 92, a pre-compensation beam guiding element 94, a pre-compensation controller 105, and a wavefront corrector 110.

The wavefront corrector 110 is arranged in the optical path between the beam expanding device 50 and the 2D tiltable mirror 80.

Between the wavefront corrector 110 and the 2D tiltable mirror 80, the pre-compensation beam guiding element 94 is arranged. The pre-compensation beam guiding element 94 comprises a semi-transparent mirror configured (a) to guide the laser beam from the wavefront corrector 110 to the tiltable mirror 80 and (b) to allow a light signal incoming from the side of the spacecraft to pass through the pre-compensation beam guiding element 94 towards the wavefront detector/camera 90/92.

The wavefront detector/camera 90/92 is configured to measure a wavefront received from the side of the 2D tiltable mirror and transmit a signal corresponding with the measured wavefront to the pre-compensation controller 105.

The pre-compensation controller 105 is connected to the processing unit 40 and to the wavefront corrector 110. The processing unit 40 is configured to communicate with the pre-compensation controller 105 to receive data related to the measured wavefront and to send instructions to the pre-compensation controller 105.
The pre-compensation controller 105 is configured to communicate with the wavefront corrector so as to provide instructions to the wavefront corrector for adapting the wavefront of the laser beam incoming from the laser source 10 and beam expanding device 50.

This embodiment provides that the optical device is capable of controlling an optical uplink to a spacecraft or object moving in airspace based on a combination of two fundamentally different pre-correction schemes in a complementary functional chain along the same optical path in the device, and has the ability to maximize overall data throughput over the entire range of varying atmospheric turbulence states, which otherwise would not be achievable by either of the precompensation schemes individually,

To maximize data throughput over an entire time of operation of the optical device, with harsh and benign atmospheric turbulence state conditions, a ground station-to-spacecraft laser beam uplink has to implement a combined adaptive pre-correction that toggles seamlessly between two main correction schemes ‘A’ (divergence adaptation+tip-tilt) and ‘B’ (AO pre-compensation). The selection is carried out by the processing unit using an algorithm that combines as inputs:
(1) In-situ information of the Fried parameter, Isoplanatic Angle and Point-Ahead Angle
(2) Statistical (historical) data of parameters from the Fried parameter, Isoplanatic Angle and Point-Ahead Angle
(3) Wavefront corrector parameters, achievable modes of correction N_Zernike as a function of the isoplanatic angle (Also)
(4) In-situ information of modulation, error correction and interleaving settings in space

The method on which the algorithm is based and carried out by the processing unit, calculates a possible maximum number of useful correction modes and inhibits higher order correction modes from being activated.

As first step, the minimum order of correction is determined by comparing to a target ratio ω₀/r₀, related to a turbulence strength where the uplink system shall operate. Based on a dedicated algorithm, a Performance Factor is determined as a function of ω₀/r₀. That Performance Factor must be greater or equal to ω₀/r₀.

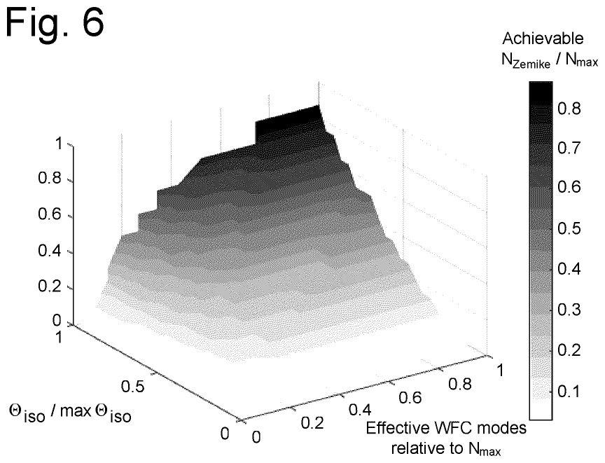

For a graphical representation of this algorithm, shown in FIG. 5, for a target of ω₀/r₀=5, the minimum order of correction, Nmin, is obtained for a Performance Factor≥5, resulting in Nmin≥36 modes from graphical evaluation of FIG. 5. As an example, for r₀=3 cm and ω₀=15 cm, 36 modes must be effectively compensated by a wavefront corrector (‘WFC’).

In the following, that minimum required number of modes, ‘Nmin’, is considered to be covered by an effective available number of modes, ‘Nmax’, of a wavefront corrector device. Accordingly, Nmax is equal or higher to the required minimum number Nmin.

The method further configures in-situ the relevant operating parameters from selected pre-compensation schemes ‘A’ or ‘B’, according to in-situ information of the Fried parameter, Isoplanatic Angle and Point-Ahead Angle parameters described in input (1). Notably, speaking in approximate, rough figures, the expected variation of the Fried parameter is expected in ~10s of seconds, while the Isoplanatic Angle changes in 10s of minutes and the Point-Ahead Angle is either fixed or varies in a ~seconds time scale. This provides sufficient room for optimization, compared to a typical atmospheric time constant in the range of milli seconds.

Seamless switching between the pre-compensation schemes is achieved by pre-setting the relevant wavefront correction settings of the wavefront corrector 110 for Scheme A or B prior to initiating a switch between the schemes. The wavefront correction settings are communicated by the processing unit to the wavefront corrector.

Switching between the two pre-correction schemes A and B enables a much higher uplink data throughput over a wider coverage of turbulence conditions. When starting from scheme A i.e., tip-tilt corrected uplink beam as baseline:

Always using the full set of higher order wavefront modes pre-correction offered by the wavefront corrector of Scheme B leads to significant dynamic losses at high confidence levels in situations of small isoplanatic angles less or equal to 70% of the Point Ahed Angle. When using Scheme A instead of Scheme B in such conditions, those dynamic losses can be reduced by more than an order of magnitude at high confidence levels.

Using only Scheme A misses opportunities to increase uplink data throughput in times of isoplanatic angles larger of equal to the Point Ahead Angle, especially for small Fried parameter r0, i.e. when high turbulence occurs close to the level of the ground station.

Dynamic monitoring of the actual turbulence state, together with information about communications subsystem (MODCOD, VCM) settings on-board the space craft's lasercom (laser beam based communications) receiver allows for selecting the optimal one from the pre-correction scheme A or B. Using historical data as mentioned in input (2) above, additionally supports near-term trend analysis for predictive pre-compensation.

During using scheme B, when matching the maximum effective wavefront corrector mode to the isoplanatic angle in the optical uplink path significantly improves the performance of adaptive optical system, while additionally preventing the otherwise wrong correction of higher order modes.

In scheme A, the optical device is capable of carrying out a method for controlling an optical uplink to a spacecraft, comprising:
providing a substantially parallel output laser beam pointing to a location along a trajectory of the spacecraft through a path in the atmosphere;
the output laser beam being provided with a beam waist;
the method further comprising adjustment of the output laser beam, the
   monitoring an image pattern obtained from a first image of a beam received from said location and a second image of a reference beam from the output laser beam;
   carrying out at least one of step a) and step b)
a) determining from the monitored image pattern a receive dynamic loss of intensity of the received laser beam along said path in the atmosphere;
   adjusting the beam waist of the laser beam depending on the receive dynamic loss in a manner that an uplink dynamic loss is reduced;
b) determining from the monitored image pattern angular motion of the beam received from said location relative to the reference beam, and
adjusting the beam waist of the laser beam depending on the determined angular motion in a manner that the uplink dynamic loss is reduced.

As will be explained below in more detail, to make use of a substantially reduced channel transmission penalty if the turbulence strength decreases, the beam waist is to be enlarged, up to a maximum value as allowed by the projection lens system. If the turbulence strength increases, the beam waist is to be reduced.

In an embodiment the laser source provides a parallel laser beam with for example a wavelength of 1.55 μm and a diameter of 2 mm. The beam expanding device 50 is configured to expand the diameter to 4 mm for the expanded beam. According to this embodiment, the projection lens system 20 has a fixed magnification of 40. Thus in this embodiment the beam waist of the beam in the atmosphere can be adjusted up to a value of 80 mm. The skilled in the art will appreciate that without limitation of the inventive concept other optical settings and/or beam sizes could be used depending on specific designs or requirements. Also, other laser beam wavelengths could be used.

As mentioned above, the present invention recognizes that in an uplink optical beam a certain range R, or slack, of the beam waist around the beam waist setpoint exists that allows for absorbing fast dynamic variations without a need to adjust the beam waist set point.

Accordingly, in a preferred embodiment, the beam waist is only adjusted when a change of the turbulence strength exceeds a threshold or tolerance value at which change of turbulence strength the quality level of the laser beam becomes adversely affected in a significant manner. If the changes are less than the threshold or tolerance value, the beam waist set point is adequate for maintaining the uplink and is thus kept unchanged. This allows that adjustment of the laser beam can be relatively slow in comparison with adaptive optics based corrections.

In an embodiment, the threshold or tolerance value is derived from a predetermined condition which may correspond to user's requirements for a particular configuration of the uplink adaptor.

In an embodiment, the optical device additionally comprises a tracking controller 60 which may be part of the processing unit 40 or may be coupled to the processing unit 40 and a 2D tiltable mirror 80 (i.e., tiltable along two axes in two perpendicular directions) that is arranged in the optical path between the beam expanding device 50 and the projection lens system 20.

The combination of the tracking controller 60 and the 2D tiltable mirror is configured to keep the laser beam directed to the spacecraft while the spacecraft is in line of sight with the ground station. The tracking controller 60 is configured to receive a position signal of the monitored reference beam and spacecraft beam spot centres (directly or indirectly from the optical detector 30), to determine a position correction signal to correct for misalignment and to send a control signal for position correction of the output laser beam to the 2D tiltable mirror 80. The 2D tiltable mirror 80 is arranged to adjust its orientation in accordance with the control signal received from the tracking controller 60.

According to an embodiment, the beam expanding device 50 is a conventional adjustable telescopic beam expander. In a further embodiment, the telescopic beam expander is attached to a gimbal (not shown) that provides coarse pointing toward the target line of sight. Alternatively, the beam expanding device 50 is combined with one or more meta-surface based elements (not shown) in which the meta-surface based element(s) are capable to control the tilt wavefront of the laser beam radiation in large angle steps, hence eliminating any external movable parts.

According to an embodiment the method further comprises: augmenting the adjustment of the beam waist of the laser beam by an external monitoring signal provided to the processing unit, the external monitoring signal being derived or determined from an external turbulence measurement device.

In a further embodiment, the external monitoring signal relates to a signal obtained from in-situ measurement of the isoplanatic angle.

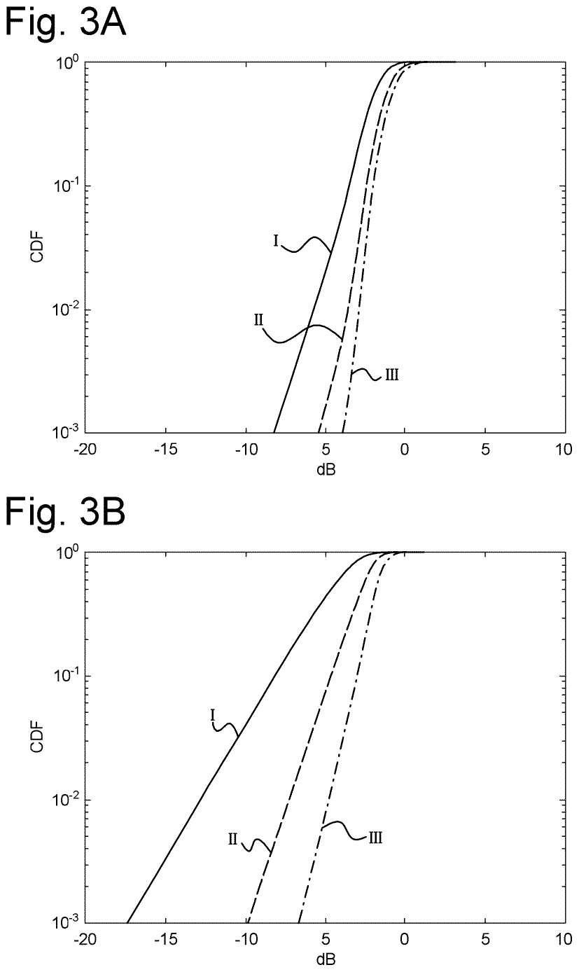

FIGS. 3A, 3B illustrate a variation of dynamic turbulence loss for two beam waist sizes.

In FIGS. 3A, 3B, the relationship of resulting dynamic uplink loss at a corresponding confidence level CDF signal (i.e. correlated to a measure of turbulence strength) is depicted for a given beam waist wo. Vertically, the CDF signal is plotted as function of the dynamic loss of transmission (in dB). In FIG. 2A the laser beam has a beam waist wo of 35 mm. In FIG. 2B the laser beam has a beam waist wo of 70 mm. In both plots the clear aperture (of the projection lens system) was 200 mm. In each of FIGS. 2A, 2B CDF signal vs dynamic loss is plotted for three different Fried parameters: line I relates to r₀=5 cm, line II to r₀=7 cm and line III to r₀=10 cm. On the Fried parameter scale, a larger Fried parameter value indicates relatively more benign turbulence conditions upwards in the atmosphere.

A comparison of line I in FIG. 3A with line I in FIG. 3B shows that for high confidence levels, about +8 dB (~factor 6) of transmission gain through the turbulent atmospheric channel can be obtained once reducing the beam waist wo by a factor 2. Notably, at the same time the far field on-axis antenna gain for the smaller beam decreases only by about 5 dB (~factor 3) in such case, which results in an overall gain of a factor 2, for the given example where r₀ remains at the same small size of 5 cm, considered high turbulence strength. At low turbulence strength, it gets preferable to fully utilize the large beam waist. Comparing line Ill in FIG. 3A with line Ill in FIG. 3B shows a much smaller transmission gain through the turbulence atmosphere of about 2 dB for using a small beam waist. When compared to the available far field on-axis antenna gain of 5 dB for the larger beam waist, about 3 dB (factor 2) overall gain is obtained when enlarging the beam waist in low turbulence strength.

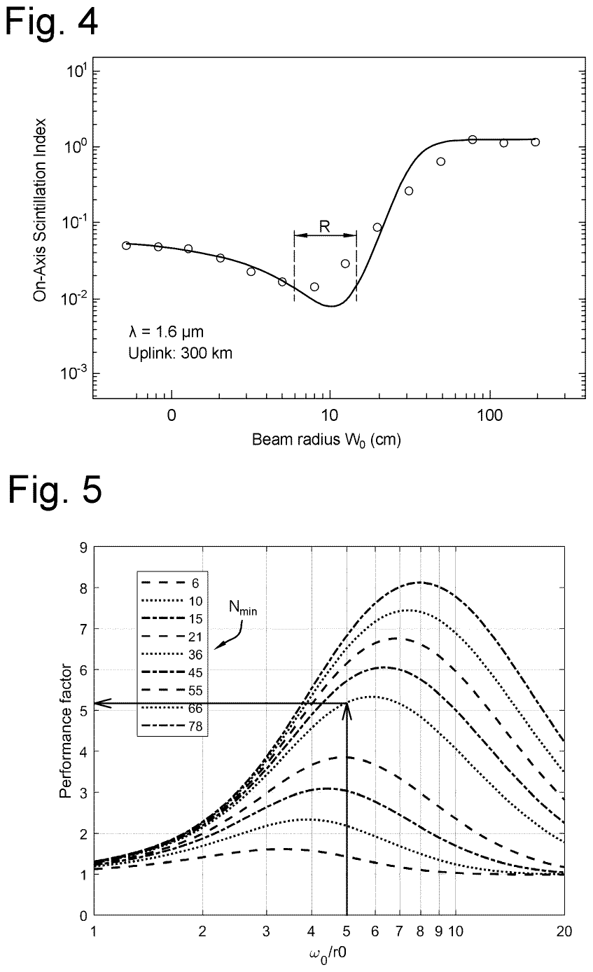

The reason for this is indicated in FIG. 4 which shows a prior art illustration of on-axis scintillation index for a laser beam as a function of the beam radius at a given turbulence strength of the atmosphere. When enlarging the beam waist by a factor 2 from its optimal value, the tracked uplink scintillation index increases by a factor 10. In that regime, the uplink scintillation index is then related in non-linear progressive way to the uplink turbulence penalty shown in the horizontal axis of FIGS. 3A, 3B.

In scheme B, the optical device is capable of carrying out a method for controlling an optical uplink to a spacecraft or object moving in airspace, comprising:
providing a substantially parallel output laser beam pointing to a location along a trajectory of the spacecraft through a path in the atmosphere;
the method further comprising adjustment of the output laser beam, the adjustment comprising: adaptation of the wavefront of the output laser beam by means of a wavefront corrector, in which wavefront correction settings are selected based on an amount of angular anisoplanatism which is a function of the ratio between the isoplanatic angle θᵢₛₒ and the Point Ahead Angle θ_{PAA}.

The selected wavefront correction settings depend on the available number Nmax of Zernike modes of the wavefront corrector and the algorithm that uses a function of the angular anisoplanatism, f(θᵢₛₒ/θ_{PAA}).

Scheme B augments the prior tip-tilt correction achieved by mirror 80 and the tip tilt controller 60. In scheme B when measuring the isoplanatic angle and using the current Point Ahead Angle information (i.e., f(θᵢₛₒ/θ_{PAA}).) the wavefront controller 105 receives these values and determines the actual number of achievable Zernike modes. By transmitting a signal corresponding with the actual number of achievable Zernike modes to the wavefront corrector 110, the wavefront controller 105 provides the wavefront corrector with an adjustment signal for the wavefront of the output laser beam that is based on a wavefront detection signal derived from wavefront detector 90.

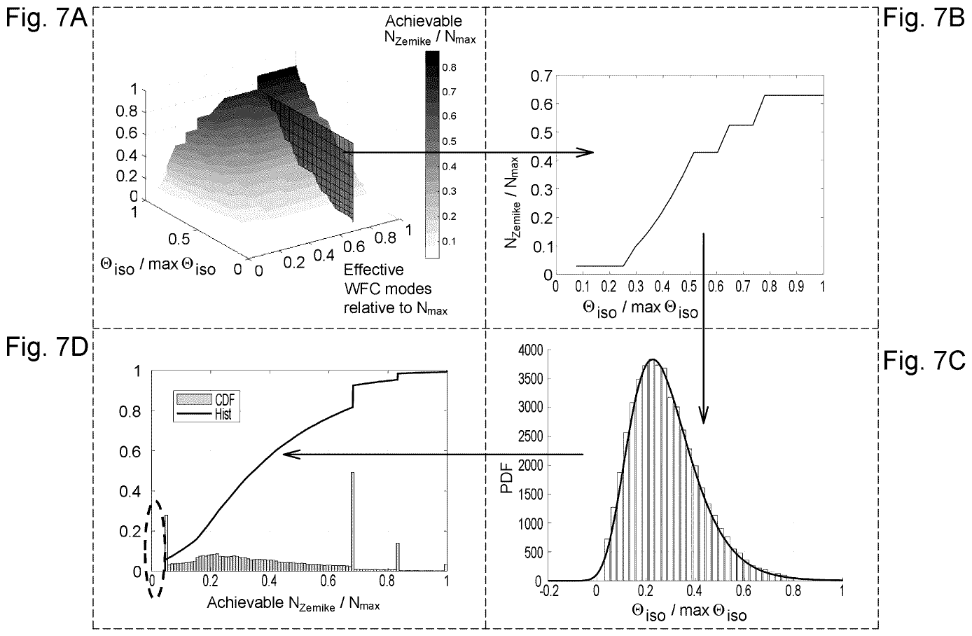

In FIG. 6, the distribution of (normalized) achievable number of Zenike modes is illustrated as a function of the (normalized) isoplanatic angle θᵢₛₒ and the (normalized) effective wavefront correction (WFC) modes.

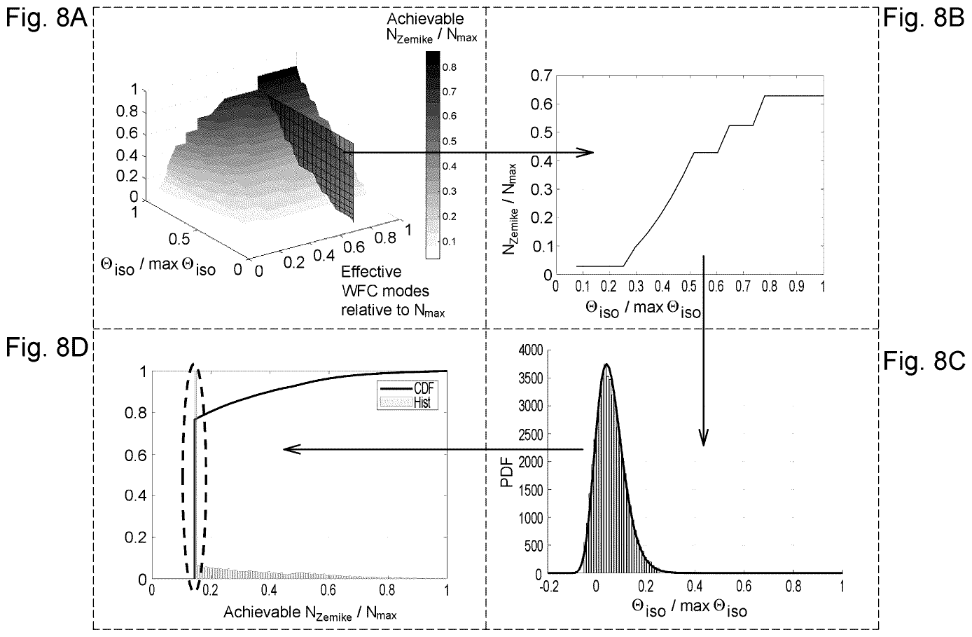

FIG. 7a-7d shows schematically how in scheme B a wavefront correction is established for long term historical measurement of isoplanatic angle θᵢₛₒ.

In FIG. 7a from a plot such as FIG. 6 the distribution of achievable number of Zernike modes is determined for a given effective number WFC modes relative to Nmax. For example the effective WFC modes are established as 75% of the available WFC modes. From the cross-section of the distribution of achievable Zernike modes at this effective WFC modes number, the number of Zernike modes as function of the isoplanatic angle θᵢₛₒ over max θᵢₛₒ, is determined as shown in FIG. 7b.

Next in FIG. 7c, the statistical data of the isoplanatic angle is shown as a PDF (probability density function), indicating historical evolution of the isoplanatic angle.

Using the data from FIG. 7c, in FIG. 7d a calculation is made of the corresponding confidence level CDF signal (i.e. correlated to the achievable number of Zernike modes).

During operation of the laser beam of the ground station, the selection by the processing unit for using either Scheme A or Scheme B is determined by two parameters: the beam waist w over Fried parameter r₀ ratio (w/r₀) and the isoplanatic angle θᵢₛₒ. over point ahead angle θ_{PAA} ratio (θᵢₛₒ/θ_{PAA}).

For comparison FIGS. 8a-8d schematically show in scheme B a wavefront correction is established for a short term (i.e. worst case) historical measurement of isoplanatic angle θᵢₛₒ.

As shown, the PDF in FIG. 8c is relatively narrow and only populated for relatively small values of θᵢₛₒ. As a result the CDF is substantially centered at low number of Zernike modes which lead to the possibility of only minor wavefront corrections. In this circumstance the processing unit will establish that the output laser beam of the optical device should be controlled under Scheme A.

Due to the statistical nature of θ_{ISO}, it is not feasible to obtain at 100% the required amount of compensating modes for a wavefront corrector to obtain the performance factor for a given ratio w/r₀ all the time, and exceptional events remain where adaptive pre-compensation is less effective than required.

Such exceptional events cause a significant increase of scintillation, with deep fades, at the space craft's on-board terminal receiving the uplink. In exceptional events, always if w/r₀>>1, then scheme B is applied, because it inherently minimizes uplink scintillation, at a noticeable reduction of average receive irradiance. Once the ratio w/r₀ shrinks due to an increasing r₀, then scheme A is selected or re-activated, and so forth.

The invention may further be defined by the following clauses:

Clause 1. A method for controlling an optical uplink to a spacecraft or object moving in airspace, comprising:
providing a substantially parallel output laser beam pointing to a location along a trajectory of the spacecraft through a path in the atmosphere;
the output laser beam being provided with a beam waist;
the method further comprising adjustment of the output laser beam, the adjustment comprising:
   monitoring an image pattern obtained from a first image of a beam received from said location and a second image of a reference beam from the output laser beam;
   carrying out at least one of step a) and step b):
step a) comprising determining from the monitored image pattern a receive dynamic loss of intensity of the received laser beam along said path in the atmosphere; and adjusting the beam waist of the laser beam depending on the receive dynamic loss in a manner that an uplink dynamic loss is reduced;
step b) comprising determining from the monitored image pattern angular motion of the beam received from said location relative to the reference beam, and adjusting the beam waist of the laser beam depending on the determined angular motion in a manner that the uplink dynamic loss is reduced.

Clause 2. The method according to Clause 1 further comprising: augmenting the adjustment of the beam waist of the laser beam by an external monitoring signal provided to the processing unit, the external monitoring signal being derived or determined from an external turbulence measurement device.

Clause 3. The method according to Clause 2, wherein the external monitoring signal relates to a signal obtained from in-situ measurement of the isoplanatic angle.

Clause 4. The method according to Clause 1, 2 or 3, further comprising
generating the laser beam by a laser source,
providing an optical device in the path of the laser beam, the optical device configured for controllably adjusting the beam waist,
controlling the optical device for adjusting the beam waist depending on the determined dynamic loss and/or the determined angular motion.

Clause 5. The method according to any one of Clauses 1-4, further comprising:
repeating the adjustment of the laser beam over time either at a predetermined time interval or based on an observed change of the dynamic loss.

Clause 6. The method according to Clause 5, wherein if the dynamic loss is decreasing over time, the method comprises enlarging the beam waist, or if the dynamic loss is increasing over time, the method comprises reducing the beam waist.

Clause 7. The method according to any one of Clauses 1-6, further comprising if a change of the dynamic loss is within a predetermined tolerance range the beam waist is not adjusted.

Clause 8. The method according to any one of the preceding Clauses, further comprising-tracking a position of the spacecraft, and—using said position in the step of pointing the laser beam to said location.

Clause 9. The method according to any one of the preceding Clauses, comprising: determining the dynamic loss based on an observed coherence length of the path in the atmosphere.

Clause 10. A device for providing an optical uplink to a spacecraft or an object moving in airspace, comprising
a laser source, a projection lens system, a beam expanding device, an optical detector and a processing unit;
the laser source configured for generating a substantially parallel output laser beam,
an optical path for the output laser beam being defined between the laser source and the projection lens system;
the beam expanding device being arranged in the optical path and configured for receiving the output laser beam from the laser source, adjusting a beam waist of the output laser beam and directing the adjusted laser beam to the projection lens system;
the projection lens system configured for receiving the adjusted laser beam and pointing a line of sight of the received laser beam to a location along a trajectory of the spacecraft through a path in the atmosphere;
the optical detector coupled to the projection lens system, configured for monitoring an image pattern obtained from at least a first image of a beam received from said location and a second image of a reference beam from the output laser beam;
the processing unit coupled to the detector and to the beam expanding device, the processing unit being configured for:
   receiving a signal from the optical detector, the signal associated with the monitored image pattern;
      determining at least one of a dynamic loss of intensity of the laser beam along said path in the atmosphere or an angular motion of the beam received from the location relative to the reference beam from the received signal;
   calculating an adjustment value for the beam waist of the laser beam depending on the determined dynamic loss and/or angular motion in a manner that an uplink dynamic loss is reduced, and
   transmitting to the beam expanding device a control signal associated with said adjustment value.

Clause 11. The device according to Clause 10, wherein the beam expanding device comprises an adjustable beam expander, optionally in combination with a metasurface-based optical device configured for coarse pointing.

Clause 12. The device according to Clause 10 or 11, wherein the optical detector is coupled to the projecting lens system by means of a semi-transparent mirror arranged in the optical path between the beam expanding device and the projection lens system.

Clause 13. The device according to Clause 12, further comprising a reflector element that is aligned with the semi-transparent mirror and the optical detector, such that a portion of the output laser beam is projected as the image of the reference beam on the optical detector via the semi transparent mirror and the reflector element.

Clause 14. The device according to any one of Clauses 10-13, wherein the detector comprises an image detector, the image detector configured for providing a digital image of the monitored image pattern.

Clause 15. The device according to Clause 14, wherein the device further comprises a 2D tiltable mirror in the optical path between the beam expanding device and the projection lens system, the 2D tiltable mirror configured for adjusting an angular position of the laser beam relative to the projecting lens system;
the processing unit is coupled to the 2D tiltable mirror and the processing unit configured for
   detecting a position of the monitored image pattern,
   determining a position correction value for adjusting the position of the monitored image pattern relative to a current position of the spacecraft, and
   based on the position correction value, controlling the 2D tiltable mirror to adjust said angular position of the laser beam so as to point to the current position of the spacecraft.

Clause 16. Computer program product on computer readable medium, holding instructions to be executed on a processing unit of a device according to any one of Clauses 10-15, the instructions after being loaded, allowing the processing unit
to receive a signal from the optical detector, the signal associated with the monitored spot pattern;
to determine at least a dynamic loss of intensity of the laser beam along said path in the atmosphere from the received signal;
to calculate an adjustment value for the beam waist of the laser beam depending on the determined dynamic loss in a manner that the measured dynamic loss is reduced, and
to transmit to the beam expanding device a control signal associated with said adjustment value.

The invention has been described with reference to the preferred embodiment. The present invention may be embodied in other specific forms without departing from its essential characteristics. The described embodiments are to be considered in all respects only as illustrative and not restrictive to the inventive concept. The scope of the invention is, therefore, indicated by the appended claims rather than by the foregoing description. It will be apparent to the person skilled in the art that alternative and equivalent embodiments of the invention can be conceived and reduced to practice. In addition, many modifications may be made to adapt a particular configuration or material to the teachings of the invention without departing from the essential scope thereof.

Above, the invention is described with reference to ground station-spacecraft topology, the skilled in the art will appreciate that the invention can be applied to connect a ground station to an object moving in airspace, for instance an aircraft, unmanned aerial system or a drone.

All modifications which come within the meaning and range of equivalency of the claims are to be embraced within their scope.

1. A device for providing an optical uplink to a spacecraft, comprising
a laser source, a projection lens system, a beam expanding device, an optical detector, a wavefront correction system, and a processing unit;
the laser source configured for generating a substantially parallel output laser beam,
an optical path for the output laser beam being defined between the laser source and the projection lens system;
the beam expanding device being arranged in the optical path and configured for receiving the output laser beam from the laser source, adjusting a beam waist of the output laser beam and directing the adjusted laser beam to the projection lens system;
the projection lens system configured for receiving the adjusted laser beam and pointing a line of sight of the received laser beam to a location along a trajectory of the spacecraft through a path in the atmosphere;
the optical detector coupled to the projection lens system, configured for monitoring an image pattern obtained from at least a first image of a beam received from said location and a second image of a reference beam from the output laser beam;
the optical detector comprising an image detector, the image detector configured for providing a digital image of the monitored image pattern;
the device further comprising a 2D tiltable mirror in the optical path between the beam expanding device and the projection lens system, the 2D tiltable mirror configured for adjusting an angular position of the laser beam relative to the projecting lens system;
the wavefront correction system comprising a wavefront detector and camera, a pre-compensation beam guiding element, a pre-compensation controller, and a wavefront corrector;
the wavefront corrector arranged in the optical path between the beam expanding device and the 2D tiltable mirror;
the processing unit communicatively coupled to the optical detector, the beam expanding device, the wavefront controller and the wavefront detector, the processing unit being configured for:
determining from the monitored image pattern a relative turbulence strength for the received laser beam along said path in the atmosphere, the turbulence strength based on a beam waist value of the output laser beam and a Fried parameter related value;
comparing the relative turbulence strength with a predetermined performance factor value;
based on the comparison, determining control of the output laser beam either using a divergence control for the beam expanding device or using a wavefront correction control for the wavefront corrector,
wherein the processing unit is configured to select the wavefront correction control if the relative turbulence strength exceeds the predetermined performance factor value, and else to select the divergence control of the output laser beam.

2. The device according to claim 1, wherein the optical detector is coupled to the projecting lens system by means of a semi-transparent mirror arranged in the optical path between the beam expanding device and the projection lens system.

3. The device according to claim 2, further comprising a reflector element that is aligned with the semi-transparent mirror and the optical detector, such that a portion of the output laser beam is projected as the image of the reference beam on the optical detector via the semi transparent mirror and the reflector element.

4. The device according to claim 1, wherein between the wavefront corrector and the 2D tiltable mirror, the pre-compensation beam guiding element is arranged; the pre-compensation beam guiding element comprising a semi-transparent mirror configured to guide a laser beam from the wavefront corrector to the tiltable mirror and to allow an external light signal received by the projection lens system to pass through the pre-compensation beam guiding element towards the wavefront detector/camera.

5. The device according to claim 1, wherein the 2D tiltable mirror is configured for adjusting an angular position of the laser beam relative to the projecting lens system; the processing unit is coupled to the 2D tiltable mirror and the processing unit is configured for
detecting a position of the monitored image pattern,
determining a position correction value for adjusting the position of the monitored image pattern relative to a current position of the spacecraft, and
based on the position correction value, controlling the 2D tiltable mirror to adjust said angular position of the laser beam so as to point to the current position of the spacecraft.

6. The device according to claim 1, wherein the wavefront correction system is configured to adapt a wavefront of the output laser beam by means of the wavefront corrector, in which wavefront correction settings are selected based on an amount of angular anisoplanatism which is a function of a measured isoplanatic angle θᵢₛₒ.

7. The device according to claim 6 wherein the processing unit is communicatively coupled to a memory unit, the memory unit configured for storing historical data of the measured isoplanatic angle.

8. The device according to claim 4, wherein the wavefront detector/camera is communicatively connected to the pre-compensation controller and is configured to measure a wavefront value of the external light signal and to transmit a signal corresponding with the measured wavefront to the pre-compensation controller.

9. The device according to claim 8 wherein the pre-compensation controller is communicatively connected to the processing unit and to the wavefront corrector.

10. A method for controlling an optical uplink to a spacecraft, comprising:
providing a substantially parallel output laser beam pointing to a location along a trajectory of the spacecraft through a path in the atmosphere;
the output laser beam being provided with a beam waist;
the method further comprising:
monitoring an image pattern obtained from a first image of a beam received from said location and a second image of a reference beam from the output laser beam;
determining from the monitored image pattern a relative turbulence strength for the received laser beam along said path in the atmosphere, the turbulence strength based on a beam waist value of the output laser beam and a Fried parameter related value;
comparing the relative turbulence strength with a predetermined performance factor value;
based on the comparison, determining control of the output laser beam either using a divergence control for the beam expanding device or using a wavefront correction control for the wavefront corrector,
wherein the processing unit is configured to select the wavefront correction control if the relative turbulence strength exceeds the predetermined performance factor value, and else to select the divergence control of the output laser beam.

11. The method according to claim 10, wherein if the divergence control of the output laser beam is selected the method further comprises adjustment of the output laser beam, the adjustment comprising:
carrying out at least one of step a) and step b)
a) determining from the monitored image pattern a receive dynamic loss of intensity of the received laser beam along said path in the atmosphere;
adjusting the beam waist of the laser beam depending on the receive dynamic loss in a manner that an uplink dynamic loss is reduced;
b) determining from the monitored image pattern angular motion of the beam received from said location relative to the reference beam, and adjusting the beam waist of the laser beam depending on the determined angular motion in a manner that the uplink dynamic loss is reduced.

12. The method according to claim 10, further comprising
generating the laser beam by a laser source,
providing an optical device in the path of the laser beam, the optical device configured for controllably adjusting the beam waist,
controlling the optical device for adjusting the beam waist depending on the determined dynamic loss and/or the determined angular motion.

13. The method according to claim 10, wherein if the wavefront correction control of the output laser beam is selected the method further comprises:
adjustment of the output laser beam, the adjustment comprising: adaptation of the wavefront of the output laser beam by means of a wavefront corrector, in which wavefront correction settings are selected based on an amount of angular anisoplanatism which is a function of a measure isoplanatic angle θᵢₛₒ.

14. The method according to claim 13, wherein the wavefront correction settings are additionally based on historical data of the measured isoplanatic angle.

15. The method according to claim 14, wherein the wavefront correction settings are determined by calculating achievable number of Zernike coefficients as a function of a set of available wavefront correction modes of the wavefront corrector and the measured isoplanatic angle.

16. A computer program product on computer readable medium, holding instructions to be executed on a processing unit of the device according to claim 1, the instructions after being loaded, allowing the processing unit to:
determine from the monitored image pattern a relative turbulence strength for the received laser beam along said path in the atmosphere, the turbulence strength based on a beam waist value of the output laser beam and a Fried parameter related value;
compare the relative turbulence strength with a predetermined performance factor value;
based on the comparison, determine control of the output laser beam either using a divergence control for the beam expanding device or using a wavefront correction control for the wavefront corrector,
wherein the processing unit is instructed to select the wavefront correction control if the relative turbulence strength exceeds the predetermined performance factor value, and else to select the divergence control of the output laser beam.
